(19) United States
(12) Patent Application Publication
(10) Pub. No.: US 2014/0380387 A1
(43) Pub. Date: Dec. 25, 2014

(54) SYSTEM, APPARATUS AND METHOD FOR UTILIZING A MULTIMEDIA SERVICE

(71) Applicant: Samsung Electronics Co., Ltd., Gyeonggi-do (KR)

(72) Inventors: Basavaraj Jayawant Pattan, Bangalore (IN); Mayuresh Madhukar Patil, Bangalore (IN)

(73) Assignee: Samsung Electronics Co., Ltd.

(21) Appl. No.: 14/365,011

(22) PCT Filed: Dec. 12, 2012
(86) PCT No.: PCT/KR2012/010779

§ 371 Date: Jun. 12, 2014

(30) Foreign Application Priority Data
Dec. 12, 2011 (IN) 4334/CHE/2011

(51) Int. Cl. H04L 29/06; H04N 21/4788; H04N 21/266

(52) U.S. Cl. CPC H04L 65/1069; H04N 21/266; H04N 21/4788
USPC 725/109

(57) ABSTRACT

In one or more embodiments a system and an apparatus for utilizing a multimedia service are provided. In one embodiment, the system includes a first client device, a media managing server and a media provider system to implement the multimedia service. The first client device is associated with a user desiring to utilize the multimedia service. The first client device includes, primarily, a processor, and a memory configured with one or more programs and is connected to the processor. The memory includes a media handling module configured for managing sensory inputs and customized outputs that are characteristic to the immersive multimedia service and a social communicator assisting in providing immersive multimedia service, the social communicator being configured for enabling social communication of the first client device with a second client device through the media managing server based on a set of user preferences provided by the user.

### TECHNICAL FIELD

The present invention relates to a system, apparatus and a method for providing an advanced multimedia service to a user. More specifically, the invention relates to system, apparatus and method for providing immersive social experience through the multimedia service to the user by bringing multiple entities together. For example, the multiple entities are brought together to manage content and enable communication between one or more client devices thereby providing real-time multimedia experience to the user.

### BACKGROUND ART

‘Telepresence’ and technology related to it were initially used where presence of individuals is not ideally required to control activities. Advancement in the telepresence technology domain has led to multiple levels of complications in both software and hardware architecture of devices used. It is mandatory that users at both the ends of the telepresence service to have such support (both software and hardware) to realize.

There may be different levels of telepresence services that are presently prevalent in the market, including light, adaptive and immersive telepresence. The light presence may be attributed to videoconferencing that is currently present to connect two or more users that possess the video capturing, transmitting and receiving facilities. Adaptive telepresence may include different angles of video capturing facilities and can be optionally changed based on user inputs. The immersive telepresence includes multiple levels of usage by the two entities namely, media provider system and user of telepresence technology. The immersive telepresence provides superior quality and close to real time experience. The users may further feel the virtual presence at a remote location with all parameters of real time experience considered.

### DISCLOSURE OF INVENTION

### Technical Problem

Further, today there are standard and non-standard enablers for multimedia content distribution and communication but they exist as individual entities without interaction among them and end user may hardly get the feel of immersive in the content being provided. With the advent of more versatile devices such as smartphones and tablets in addition to large display devices, it may be perceived as it is being even more challenging to discover the user environment at any given time and deliver the integrated content viewing and communication which gives user a being-there and being-with experience.

### Solution to Problem

In one aspect of the present invention, an apparatus for utilizing a multimedia session is provided. The apparatus includes a processor, a memory connected to the processor, the memory configured with one or more programs to perform set of steps with the assistance of processor, the set of steps including enabling viewing of a multimedia content received from a media provider system, establishing social communication with one or more client devices that are enabled for viewing the multimedia content, and integrating the view of the multimedia content and the social communication with the one or more client devices.

In another aspect of the present invention, a system for utilizing the multimedia session is explained. The system includes a media managing server for providing the immersive multimedia service, and a first client device connected to the media managing server to utilize immersive multimedia service, the first client device includes a processor, and a memory connected to the processor, the memory including a media handling module configured for managing sensory inputs and customized outputs that are characteristic to the immersive multimedia service, and a social communicator assisting in providing immersive multimedia service, configured for enabling social communication of the first client device with a second client device though the media managing server based on a set of user preferences provided by the user.

In yet another aspect of the present invention, a method of managing an immersive multimedia service is provided. The method includes the steps of retrieving a set of preferences stored by a user to configure the immersive multimedia service, transmitting a request to a server for establishing the immersive multimedia service, providing a source of multimedia content along with the request to establish the immersive multimedia service, and receiving a processed from the server based on the set of user preferences and predefined policies.

### Advantageous Effects of Invention

As is apparent from the foregoing description, exemplary embodiments of the present invention enable an advanced multimedia service provision to a user.

### BRIEF DESCRIPTION OF DRAWINGS

FIG. 1 illustrates a schematic view of a system to provide a multimedia service in accordance with an embodiment of the present invention.

FIG. 2a illustrates a schematic view of a system and associated components for providing the multimedia service, in accordance with an embodiment of the present invention.

FIG. 2b illustrates a schematic view of a system and associated components for providing the multimedia service, in accordance with another embodiment of the present invention.

FIG. 3a illustrates a first option of deploying the multimedia service and system associated with in accordance with an embodiment of the present invention.

FIG. 3b illustrates a second option of deploying the multimedia service and system associated with in accordance with an embodiment of the present invention.

FIG. 3c illustrates a third option of deploying the multimedia service and system associated with in accordance with an embodiment of the present invention.

FIG. 3d illustrates a fourth option of deploying the multimedia service and system associated with in accordance with an embodiment of the present invention.

FIG. 4 illustrates a flow diagram of providing the multimedia service in accordance with an embodiment of the present invention.

FIG. 5 illustrates a flow chart denoting a set of steps performed at a first client device in accordance with an exemplary embodiment of the present invention.

FIG. 6 illustrates a flow chart denoting a set of steps performed at a media managing server in accordance with an exemplary embodiment of the present invention.

The figures that are provided in the present invention are for illustrative purposes only and in no way to be considered as limitations.

### BEST MODE FOR CARRYING OUT THE INVENTION

The present invention provides method, system and apparatus for utilizing multimedia service. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

Further, in an exemplary embodiment, the present invention proposes a service-level framework to enable integration of content viewing and communication for immersive content experience, including in a multiple devices environment, while providing a multimedia service that provides the immersive content experience. Some of the examples where the present invention can find application includes events like leisure (e.g. sports, music), personal (e.g. weddings, birthdays, and anniversaries), organizational (e.g. seminars, conferences, product launch, trade fair), cultural (e.g. ceremonial, religious) etc.

Throughout the specification, the terms “multimedia session”, and “multimedia service”, are used interchangeably. Further, an immersive multimedia service or an immersive multimedia session shall refer to the term “multimedia service or multimedia session”.

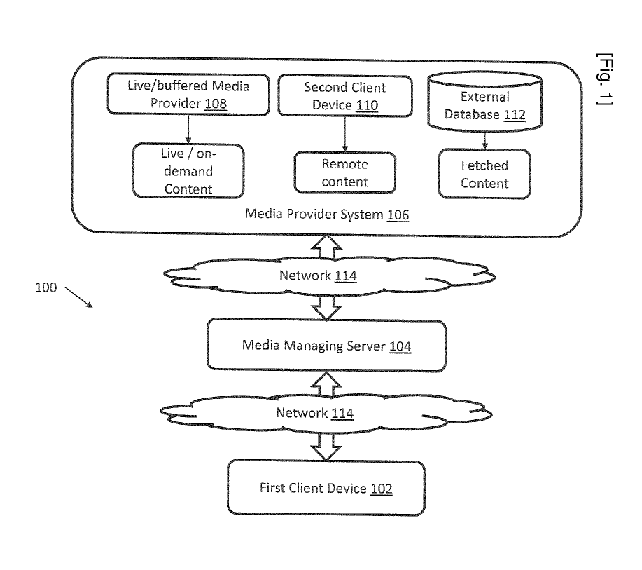

FIG. 1 illustrates a schematic view of a system 100 to provide a multimedia service in accordance with an embodiment of the present invention.

The system 100 has components of multiple levels as illustrated in the figure. The system includes primarily, a first client device 102, a media managing server 104, and a media provider system 106. The connection between the first client device 102 and the media managing server 104 is established by having network 114 which can be wired, wireless or a combination of both. In accordance with the present embodiment, the first client device 102 associated with a user can experience multimedia services through the media managing server 104. The types of contents that can be requested by the user of the first client device 102 includes live content from a live or buffered content or on-demand media provider 108, remote content from a second client device 110, intended to be connected with the first client device 102, and a fetched content (live or recorded) from a database 112 such as from any website that is connected through the internet with the first client device 102.

In an embodiment, the media managing server 104 acts as a convergence layer which is responsible of delivering the multimedia service based on selection, configuration, policy, and set of preferences of the user (the first client device 102) and the content provider (108, 110 or 112) for an event.

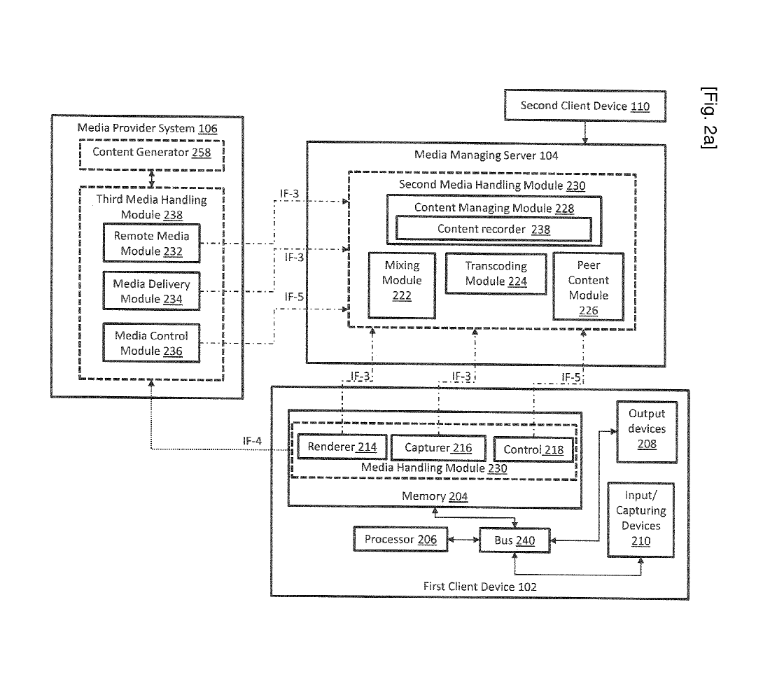

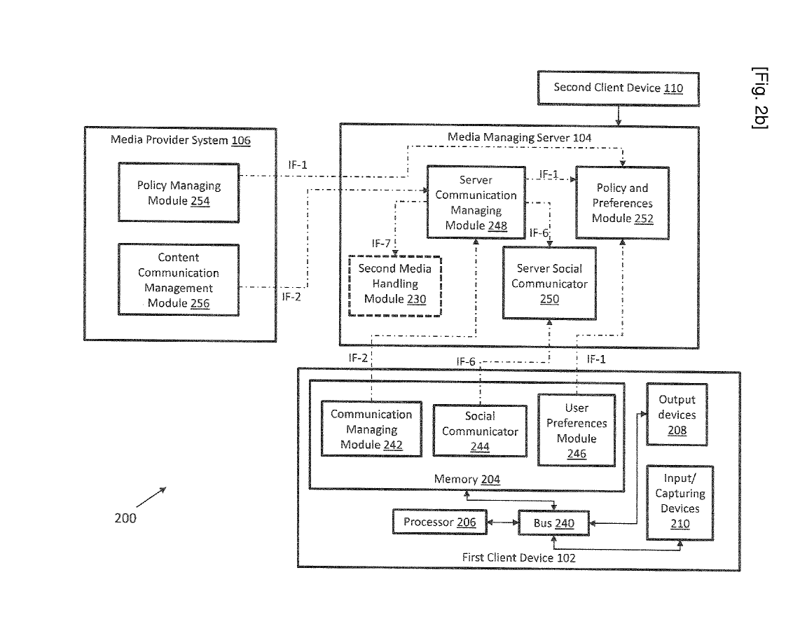

FIG. 2a illustrates a schematic view of a system 200 and associated components for providing the multimedia service, in accordance with an embodiment of the present invention.

The system 200 includes the first client device 102, the media managing server 104, the media provider system 106 and the second client device 110 in accordance with the present embodiment. In accordance with one or more embodiments of the present invention, the second client device 110 is and can be a part of the media provider system 106. For example, when the first client device 102 and the second client device 110 engage in a multimedia session through the media managing server 104, in the perception of the first client device 102, the second client device 110 is a multimedia content provider.

In the present embodiment, the first client device 102 includes a memory 204, a processor 206, output devices 208, input or media capturing devices 210 that are associated with it. For example, the output devices 208 can be audio rendering devices such as a speaker, and a video rendering devices such as displays, monitors, television and so on, the input devices 210 can be audio capture devices such as microphone, a video capturing devices such as camera, a control input capture device such as keyboard, remote joystick, keypad, mice and so on, and sensor devices like audio activity sensing, motion sensing and so on. The memory 204 with a plurality of modules, in association with the processor 206, input devices 210 and output devices 208 performs set of functions to establish a multimedia session for the user of the first client device 102.

The memory 204 includes a media handling module 230. In accordance with an embodiment of the present invention, the media handling module 230 is configured for managing sensory inputs and customized outputs that are characteristic to the multimedia service. In order to facilitate such managing functions within, the media handling module 230 includes a rendering module 214 (alternatively called as ‘renderer’), a capturing module 216 (alternatively called as ‘capturer), and a controlling module 218 (alternatively called as ‘control).

In an exemplary embodiment, the media handling module 230 is configured for managing rendering, capturing and controlling functionalities of the first client device 102. The rendering module 214 of the media handling module 230 is configured for distributing and rendering the media streams to devices such as monitor, mobile communication devices, television, speakers and so on. The capturing module is configured for collecting audio and video streams from the connected input devices 210 such as microphones, cameras and so on. The capturing module is further configured for collecting any sensor inputs connected to the firs client device 102.

The controlling module 218 is configured to enable the user of the first client device 102 to modify the streams configuration during a multimedia session. The output of the multimedia session is provided on the screen of one of the output devices 208. In an expansive embodiment, the controlling module 218 enables the user of the first client device 102 to manage the recording functions that is being performed at the end of the media managing server 104 locally. The recording functions may include ON, Off, pause and so on. In an exemplary embodiment, a content managing module 228 including a content recorder 238, present in the media managing server 104 enables user of the first client device 102 to retrieve multimedia information and manage history of event recordings stored on the media managing server 104.

Further in the present embodiment, the media managing server 104 includes the second media handling module 230 to manage multimedia content at the media managing server 104. In an embodiment, the media managing server 104 is configured for performing at least one of converting multimedia provided in accordance with the user preferences and policies, retrieving a multimedia content from the media provider system 106 in accordance with an multimedia service request from the first client device 102, storing the multimedia content pertaining to the multimedia service request, and serving the multimedia content to the first client device 102.

The second media handling module 230 includes a content managing 228 including the content recorder 238, a mixing module 222, a transcoding module 224, and a peer content module 226. The mixing module 222 is configured for enabling one or more multimedia streams to be mixed and delivered during the multimedia session. In an embodiment, the mixing module 222 receives instructions from a server communication managing module 228 (refer to FIG. 2b). The transcoding module 224 is configured for encoding the one or more multimedia streams in one or more formats that is characteristic to an on-going multimedia session. For instance the transcoding module 224 may receive instructions through the server communication managing module 228, the instructions shall be provided by user of the first client device 102. The peer content module 226 is configured for receiving and managing multimedia contents from multiple client devices such as the second client device 110 connected to the media managing server 104.

The content managing module 238 is configured to enable managing contents such as deferred contents, fetched contents, and recorded contents at the media managing server 104. The deferred content may refer to contents that are temporarily to the first client device 102 and the fetched content may refer to multimedia obtained from a third party such as database 112 to be provided for the first client deice 102. The content recorder 238 is capable of storing the history of past multimedia communication sessions for relaying the communication sessions in future on-demand. Further, in an embodiment the content recorder 238 functioning is initiated by inputs from the user of the first client device 102 through the communication managing module 228.

In the FIG. 2a, the media provider system 106 includes a third media handling module 238 for managing multimedia that is to be delivered to the media managing server 104 during the multimedia session. The third media handling module 238 includes a remote media module 232, a media delivery module 234, and a media control module 236. For example, the remote media module 232 is configured to manage functions related to multimedia content associated external content providers such as a content generator 258. The content generator 258 includes external devices such as capturing devices, audio/video input devices that are present in a real time location. For example, if a live concert happening at a remote location is requested by the user of the first client device 102, the content generator 258 shall include cameras, microphones and so on. The multimedia content provided by the content generator 258 is managed and customized by the media control module 236. The media delivery module 234 is configured for delivering multimedia to the media managing server 104, more particularly, the second media handling module 230.

In accordance with the present embodiment, in one or more implementations, the media sharing between the first client device 102 and the media managing server 104 and between the media managing server 104 and the media provider system 106 occur through a combination of a third interface (represented as IF-3) and a fifth interface (represented as IF-5) in the FIG. 2a.

In an embodiment, the third interface IF-3 is exposed by the second media handling module 230 on the media managing server 104 to transfer/exchange one or more multimedia streams between other components such as the media provider system 106 and the first client device 102. Some of the supported functionalities of the third interface include receiving multimedia streams, and send multimedia streams. In the same embodiment, the fifth interface IF-5 is exposed by the second media handling module 230 on the media managing server 104 which allows components such as the media provider system 106 and the first client device 102 to control the in-session multimedia streams. Further, some of the supported functionalities of the fifth interface IF-5 include in-session (multimedia session) streams advertisement, in-session (multimedia session) streams configuration, trigger recording functionality, deferred delivery request, fetched content request, buffer media from communication session and manage the buffered media.

In an exemplary embodiment, the first client device 102 communicates to establish the multimedia session directly with the media provider system 106. The interface that facilitates such a session or service is provided as fourth interface, denoted as IF-4. For instance, the fourth interface, IF-4 is exposed by the third media handling module 238 present in the media provider system 106. The fourth interface is configured to enable other functional components such as the media managing server 104 and the first client device 102 to receive multimedia streams from the media provider system 106. One of the supported functionalities of the fourth interface IF-4 includes transmitting multimedia streams.

FIG. 2b illustrates a schematic view of the system 200 and associated components for providing the multimedia service, in accordance with another embodiment of the present invention.

In the present embodiment, the memory 204 of the first client device 102 includes a communication managing module 242, a social communicator 244, and a user preferences module 246. The user preferences module 246 is configured to enable the user of the first client device 102 to provide a set of preferences for customized delivery of service and scheduling of service and so on. For example, the one or more multimedia streams provided by the media managing server 104 is to be customized in accordance with user's set of preferences, such as speed of play, timing of advertisements, skipping of advertisements, angle of view of an event broadcasted, and so on and so forth. The social communicator 244 is configured to enable user of the first client device 102 to retrieve and manage information of another user, at the end of media provider system 106 or the second client device 110, information includes social networking profile, activity feeds, viewing feeds, current multimedia session feeds, and the like.

The communication managing module 242 is configured to enable the user of the first client device 102 to initiate, participate, and terminate communication sessions with the media provider system 106 and other User(s) such as the second client device 110. The multimedia sessions established through the communication managing module 242 could be for retrieving a preview, viewing a program guide, retrieving on-demand content and the like. The communication managing module 242 also enables the user of the second client device 110 to understanding layout of the multimedia session, streaming of advertisement during the session, and configuring the media provider system 106 and the second client device 110.

In the present embodiment, the media managing server 104 connected to the first client device 102 facilitates streaming of multimedia content from different sources. A ‘source’ of the multimedia content can be the media provider system 106 or the second client device 110 connected to the media managing server 104 intended to provided multimedia session. The media managing server in accordance with the present embodiment includes an internal processor (not shown in the figure). The configuration and working of servers are well known in the art which includes plurality of hardware components that are not included in the description.

The media managing server 104 includes a server communication managing module 248, a policy and preferences module 252, and a server social communicator 250. The server communication managing module 248 is in active communication with the second media handling module 230 (explained in detail in FIG. 2a). The server communication managing module 248 the media managing server 104 is configured for enabling to handle sessions between multiple sources of multimedia streams such as the media provider system 106 and the second client device 110, deciding multimedia streams configuration for each of client devices (102, and 110) utilizing the multimedia session, controlling functions related to recording of multimedia contents by communicating with the content recorder 238, retrieving content from one or more sources, uploading participant information with respect the multimedia sessions by communicating with the peer content module 226, retrieving on-demand content from one or more sources, such as the media provider system 106 and the second client device 110, retrieving preview content and program guide, and retrieving policy and user preferences by communicating with the policy and preferences module 252.

Further the server communication managing module 248 can also act as the network-side proxy for the first client device 102, including the coordination of the interaction with the one or more sources of the multimedia content that is to be provided to the first client device 102.

In the present embodiment, the server social communicator 250 is configured for managing information (profile, social activity, communication session information) related to the participant of the multimedia session and providing this information to users of the first client device 102 or the second client device 110 on receiving request. This may be performed by the interaction with the peer content module 226 present in the second media handling module 230. In the same embodiment, the policy and preferences module 252 enables the media provider system 106 to define policies for the multimedia session. The module 252 further enables the first client device 102 to manage preferences for delivery of the multimedia service or session.

In the present embodiment, the media provider system 106 includes a policy managing module 254 and a content communication management module 256. The media provider system 106 is responsible for providing content as requested by the user of the first client device 102 through the media managing server 104. The policy managing module 254 is configured to enable the media provider system 106 to define set of policies that can be used for establishing the multimedia session. The content communication management module 256 is configured to enable the media provider system 106 to initiate process and terminate multimedia or communication sessions for example, feeding multimedia streams, layout, streams advertisement and so on and so forth.

In accordance with various embodiments, dedicated interfaces are used for bridging components of the system 100. In accordance with one embodiment, a first interface, denoted as IF-1 in the FIG. 2b. For illustration, the first interface (IF-1) is exposed by the policy and preferences module 252 to enable other functional components of the system 100 such as the first client device 102, the second client device 110, and the media provider system 106 to configure and apply the customized service delivery. Some of the supported functionalities of the first interface include defining polices for the multimedia service, storing and managing set of preferences provided by the user of the client devices 102 and 110, retrieving policy and preferences pertaining to existing multimedia service and managing schedules of various sessions for each of the user of the multimedia service. The second interface, denoted as IF-2 is exposed by the server communication managing module 248 of the media managing server 104, the IF-2 enables entities such as the media provider system 106 and the first client device 102 to initiate, establish, and terminate the multimedia sessions and to exchange multimedia streams in multimedia session such as the ones involving one to one sessions or group sessions. Some of the supported functionalities of the IF-2 include enabling communication session signaling, enabling signaling of on-demand content session, requesting preview and program guide, exchanging layout, streaming advertisement, streaming configuration, and recording request.

Further, in accordance with various embodiments, a sixth interface, denoted as IF-6 is utilized. For example, the sixth interface is exposed by the social communicator 244 to enable other functional components such as the server communication managing module 248 for updating the server social communicator 250 and functional components such as the first client device 102 to retrieve participant information of the multimedia service such as profile, and activity. Some of the supported functionalities of the sixth interface include storing participant information during communication or multimedia session, and retrieving participant information inside or outside the communication session.

Furthermore, in accordance with various embodiments, a seventh interface, denoted as IF-7 is provided. For illustration, the IF-7 is exposed by the second media handling module present in the media managing server 104. The IF-7 is configured to enable other functional components such as the server communication managing module 248 to initiate, establish, terminate various multimedia sessions and to exchange multimedia streams present in one to one sessions or group sessions. Further, the seventh interface (IF-7) is also used to instruct the second media handling module 230 to retrieve multimedia session related information from a third party such as the database 112, manage recording activity in the media managing server 104, and manage recorded content. Some of the supported functionalities of the seventh interface, IF-7 include start, stop, and manage recorded content, pause and play the live content, retrieve associated content from the third party such as the database 112.

Further, FIGS. 2a and 2b may illustrate one or more architectural components that are configured to enable multimedia service delivery and management by bridging the first client device 102 with the media managing server 104 and the media managing server 104 with the media provider system 106. The functionality of multimedia service delivery and management may be assisted by the first media handling module 230, the communication managing module 242 and the social communicator 244. In accordance with the present embodiment, one or more features that enable the user to experience the multimedia service are provided. The first client device 102 is enabled to integrate viewing and managing media from the media provider system 106 and the media managing server 104 and communicate with other users which can be one to one communication and one to many communications.

Further, the first client device 12 is configured to enable suggesting or recommending contents as provided by the media provider system 106 to other users involved in the multimedia session. Furthermore, the first client device 102 is configured to enable delegation of viewing rights of the multimedia content from the media provider system 106 among existing users or participants of the multimedia session. The first client device 102, more specification is enabled for managing content viewing and communication in immersive environments such as spatial media distribution among users, distribution of continuous or discrete content views across multiple screens of one or more devices and so on and so forth.

In another embodiment, the first client device 102 is configured to enable content viewing and communication in heterogeneous or multi-device environment such as mobile communication devices, tablet devices, televisions, and other devices with large displays. The memory 204 configured with one or more programs, enables the first client device 102 for storage and management of viewed content. For example, management functions related to viewed content may refer to retrieving, deleting, sharing and the like. The social communicator 244 with the assistance of the media managing server 104 can enable the first client device 102 to experience a contextual presence such as getting a list of viewing participants of the multimedia session, notification that one of the participants is watching a same/different view of the same show and the like.

Further, in an expansive embodiment, the media handling module 230 and the communication managing module 242 enable the first client device 102 for supplementary data sharing. The supplementary data sharing may refer to or includes sharing of content and contacts between viewing participants, sharing live/auxiliary content during the multimedia session to its watchers, user broadcasted content sharing and the like. The other functions that are enabled in the first client device 102 through one or more modules that are stored in the memory 204 as programs are user interaction in the context of the content being viewed such as request to synchronize content viewed with another friend or the second client device 110, user participation with the media provider system such as sending/receiving request for user interaction (e.g. for voting), merging user video with the providers of multimedia content and the like.

In another expansive embodiment, the memory 204 includes modules in the form of executable programs with the help of the processor 206 for creation, searching and sharing of the multimedia content and related metadata information such as current watchers, trends, hot topics, bookmarks, content tags, location and popularity of the multimedia content.

One of the implementation modes of the architecture as illustrated in FIG. 2a and FIG. 2b is provided. For example, a first user of the first client device 102 initiates an immersive social center service and retrieves a list of available programs. The first user may select for example, a celebrity interview program. On receiving the selection, the media managing server 104 may determine the configuration of the first client device 102. Thereafter, the media managing server 104 may provide a view of the show on the display unit of the first client device 102. The user of the first client device 102 shall receive the show with visual effect and audio with spatial effects that is similar to real time or live conditions. Further, the first user shall receive a notification that a second user of the second client device 110 is one of the participants of the celebrity interview program. Also, the user of the first client device 102 can initiate a one to one chat session with the user of the second client device 110 while watching the show together.

In one or more embodiments, the first client device 102 can be a collective terminology for one or more client devices such as a television monitor and group of audio speakers connected to a mobile communication device and similar set ups. The first client device 102 can also be a conglomerate and connected to one or more media output devices that are used to provide immersive multimedia experience to the user of the first client device 102. The first client device 102 distributes the multimedia content to the each of the media delivering devices. For example, the user of the first client device 102 may receive the media through a mobile communication device and distribute the multimedia through the media delivering devices such as monitors and speakers or other electronic devices.

In an embodiment, the user of the first client device 102 shall store one or more user preferences in the user preferences module 246. Based on the user preferences, the media managing server 104 shall provide customized services. For example, as provided in the previous embodiment, the user of the first client device 102 can be a participant in the multimedia session. When a new celebrity enters in the celebrity program, the user of the first client device based on the preferences and settings shall get automatically additional information about the celebrity (filmography, biography) on the first client device 102. Further, the user of the first client device 102 can get notified about the show watchers who are interested in the same information during the show. The user can initiate any type of communication with them (e.g., post comment, chat, audio/video communication). Further during the broadcast of the celebrity interview program, the celebrity may provide a few photos for displaying to viewers. The photos that are provided by the celebrity may be opened at a separate display unit connected to the first client device 102 such as a television monitor and so on. Further, the movement of photos in the program is traced updated in the display unit accordingly.

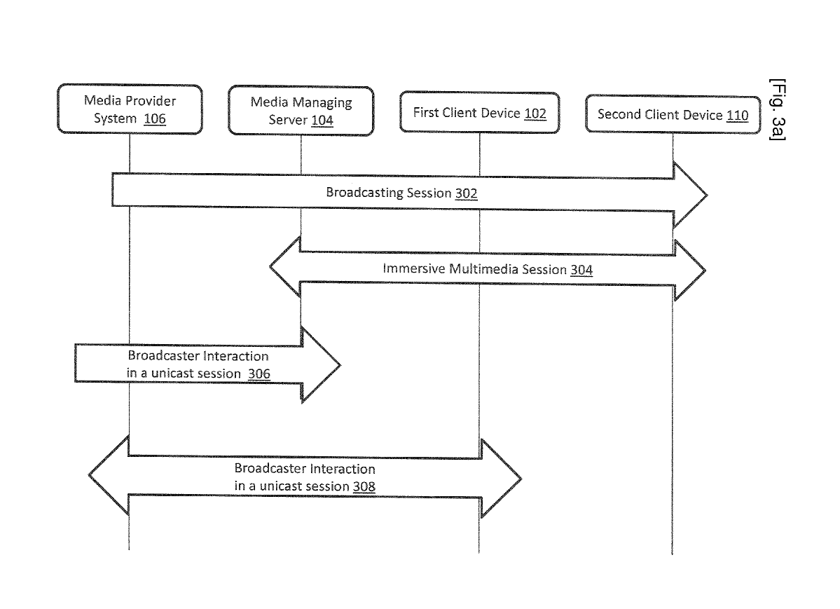

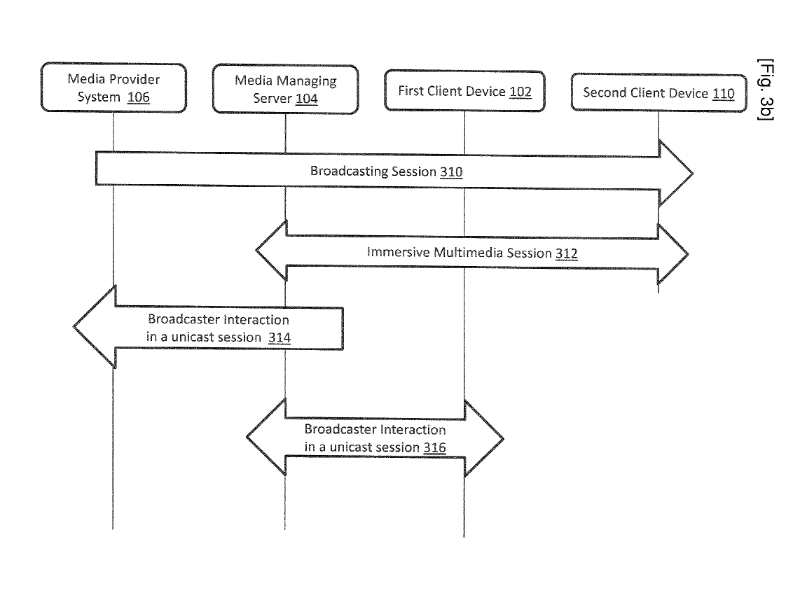

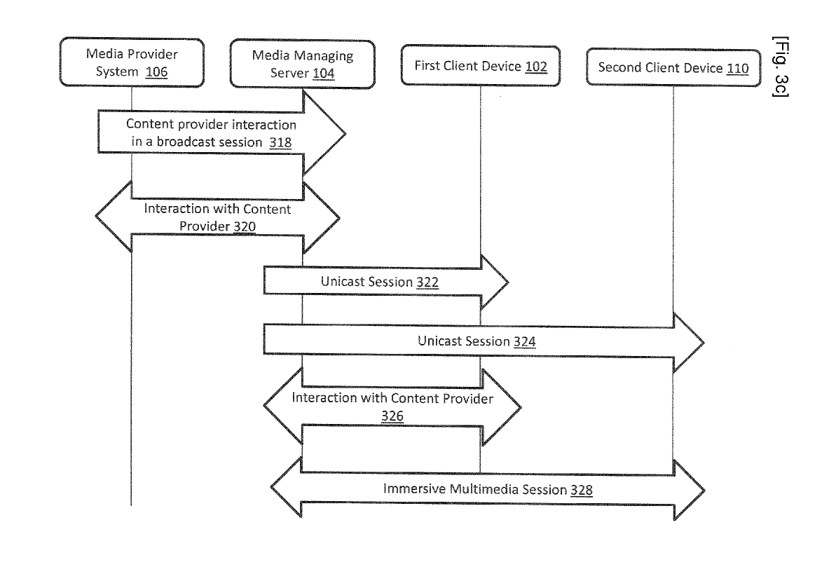

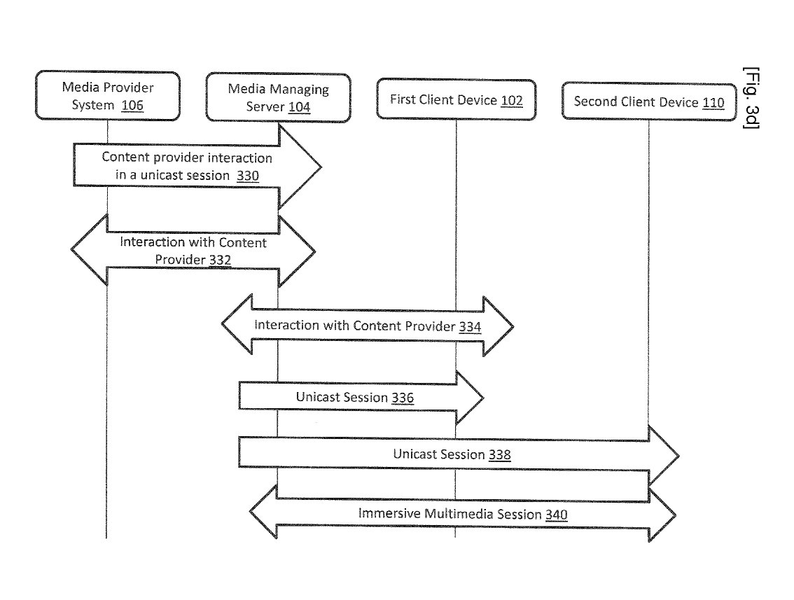

FIG. 3a illustrates a first option of deploying the multimedia service and system associated with in accordance with an embodiment of the present invention.

In accordance with the first option of deploying the multimedia service and the system, the media provider system 106 establishes a broadcasting session with the media managing server 108, the first client device 102, and the second client device 110, denoted by 302. The broadcasting session 302 may be for same content with the media managing server 108, the first client device 102, and the second client device 110. As denoted by 304, an immersive multimedia session, one of the multimedia sessions can be deployed where the first client device 102 is connected with the second client device 110. A close to real time experience is provided through the immersive multimedia session as denoted by 304. All or selective components of each of the first client device 102, the second client device 110 and the media managing server 108 can be used for establishing the immersive multimedia session. A unicast session is established to transmit multimedia from the media provider system 106 to the media managing server 104, denoted by 306. A broadcaster interaction session, denoted as 308 between the media provider system 106 and the first client device 102 is established. In accordance with the present deployment option, the sessions 306 and 308 can be established through for example, through network protocols such as Session Interaction Protocol/Real time Transport Protocol (SIP/RTP). Further, it shall be noted that the broadcaster interaction session 308 is established without the assistance of the media managing server 104.

FIG. 3b illustrates a second option of deploying the multimedia service and system associated with in accordance with an embodiment of the present invention.

Steps 310 and 312 are similar to the broadcasting session 302, and the immersive multimedia session 304 and hence, will not be explained further. A broadcaster interaction session 316 is initiated at the end of the first client device 102 and the broadcaster feedback interaction session 314 occurs between the media managing server 104 and the media provider system 106. In accordance with the present deployment option, the sessions 314 and 316 can be established for example, through network protocols such as Session Interaction Protocol/Real time Transport Protocol (SIP/RTP).

FIG. 3c illustrates a third option of deploying the multimedia service and system associated with in accordance with an embodiment of the present invention.

In the third option of deploying the multimedia service and system, the content provider 102 interaction in the broadcasting session is performed with the media managing server 104, denoted as 318. Thereafter, the first client device 102 and the second client device 110 receive the content through separate unicast sessions as mentioned in 322 and 324. In the present deployment option, the media provider system 106 can interact with the client devices 102 and 110 by scheduling a separate interaction session with the media managing server 104, as denoted in 320. The first client device 102 sends an interaction message through a unicast session, as denoted in 326. In accordance with the present deployment option, the sessions 320 and 326 can be established, for example, through network protocols such as Session Interaction Protocol/Real time Transport Protocol (SIP/RTP). Further, in the present deployment option, the first client device 102, and the second client device 104 engage in an immersive multimedia session, as denoted by 328.

FIG. 3d illustrates a fourth option of deploying the multimedia service and system associated with in accordance with an embodiment of the present invention.

A unicast session is established between the media managing server 104 and the media provider system 106, as denoted by 330. The media managing server 104 receives the content through the unicast transmission. Thereafter, the media managing server 104 transmits the content through unicast sessions, 336 and 338 to the first client device 102 and the second client device 110. The first client device 102 interacts with the media provider 106 through a separate unicast session, denoted by 334. In accordance with the present deployment option, the sessions 332 and 334 can be established for example, through network protocols such as Session Interaction Protocol/Real time Transport Protocol (SIP/RTP). The immersive multimedia session, 340 between the first client device 102 and the second client device 110 is performed with the help of the media managing server 104.

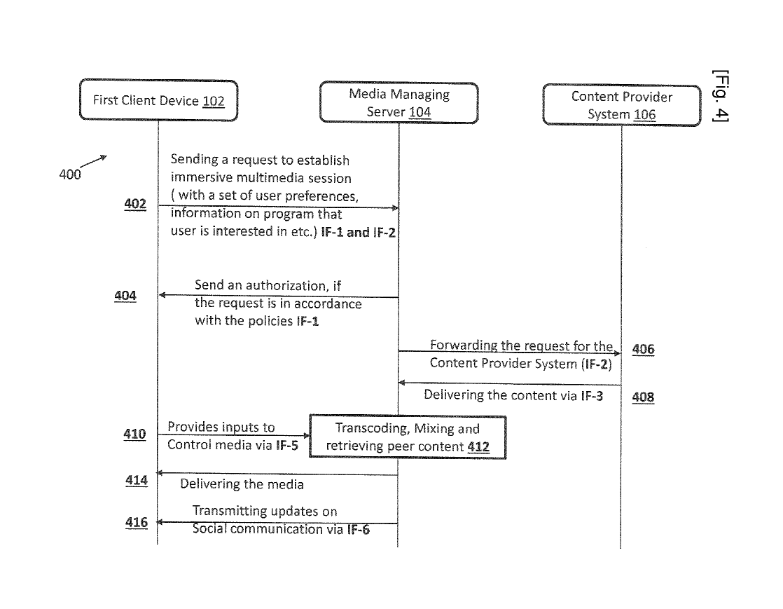

FIG. 4 illustrates a flow diagram 400 of providing the multimedia service in accordance with an embodiment of the present invention.

At step 402 the first client device 102 sends a request to establish a multimedia session (with a set of user preferences, information on program that user is interested in etc.) for retrieving a multimedia content using the interfaces IF-1 and IF-2. On receiving the request, if the request is in accordance with the policies present in the media managing server 104, an authorization is provided, as denoted at step 404. The first interface IF-1 facilitates the authorization transmission. At step 406, the media managing server 104 acts as a proxy server and forwards the request to the media provider system 106 through the interface IF-2 to retrieve the content as requested. At step 408, through the interface IF-3, the requested content is delivered by the media provider system 106 to the media managing server 104. Thereafter, one or more inputs may be provided by the user of the first client device 102 to control the multimedia content received at the media managing server 104, as denoted at 410. The fifth interface IF-5 facilitates transmission of the control inputs from the first client device 102.

At step 412, the media managing server 412 processes the multimedia content based on the received control inputs with the help of at least one of the mixing module 224, the transcoding module 226, and the peer content module 228. The media managing server 104, at step 414, delivers the multimedia content as request by the user of the first client device 102. Based on the set of user preferences, the media managing server 104 may provide updates on social viewing and activities of peers, if subscribed by the user of the first client device 102 through the sixth interface, IF-6, as denoted in 416.

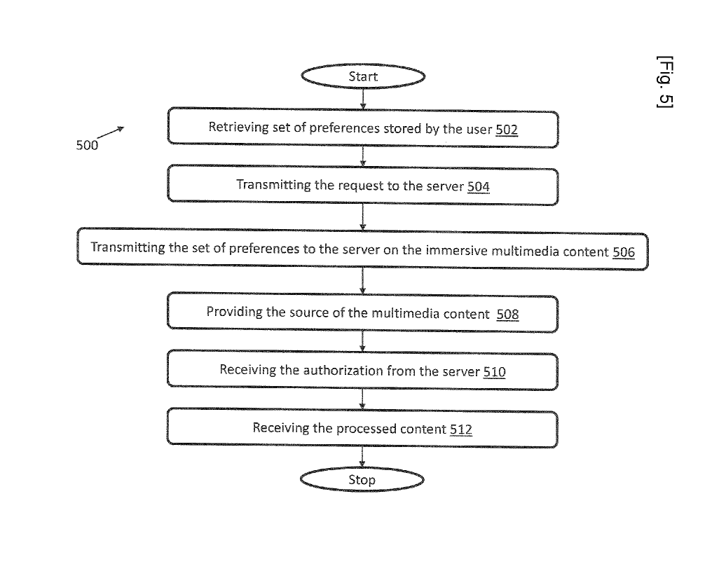

FIG. 5 illustrates a flow chart 500 denoting a set of steps performed at the first client device 102 in accordance with an exemplary embodiment of the present invention. The flow chart 500 denotes the method of managing an multimedia service or session in a network, in accordance with an embodiment of the present invention. It may be perceived that steps 502 to 512 are performed at the first client device 102 in accordance with the present invention.

At step 502, a set of user preferences received or stored at the first client device 102 is retrieved that is pertinent to configure the on-going multimedia session between the first client device 102 and the media managing server 104. Thereafter, transmitting a request to the media managing server 104 is performed by the first control device 102. The request is sent through the first interface IF-1. At step 506, the retrieved set of user preferences is transmitted to the media managing server 104. At step 508, a source or a link to communicate with the media provider system 106 is provided by user of the first client device 102. For example, the source can be the media provider system 106. An authorization is received for establishing the multimedia session between the first client device 102 and the media managing server 104, the step is denoted by 510. At step 512, a processed content, for example, transcoded and mixed content or with the peer content is received from the media managing server 104.

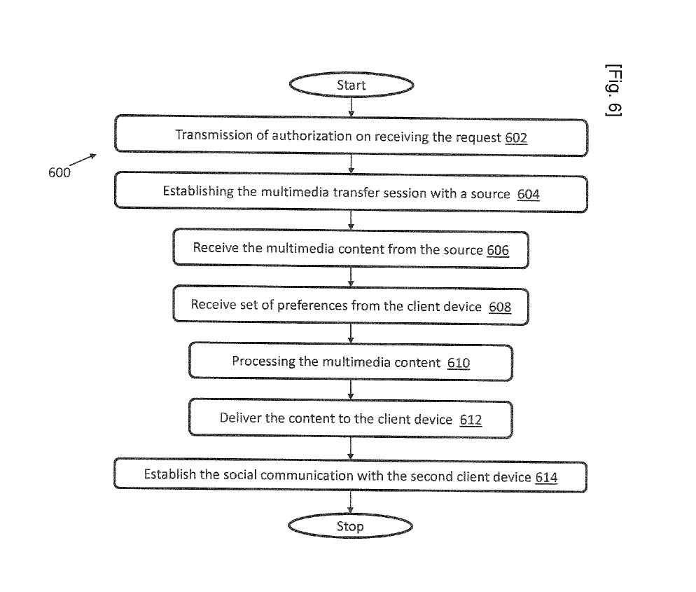

FIG. 6 illustrates a flow chart 600 denoting a set of steps performed at the media managing server 104 in accordance with an exemplary embodiment of the present invention. The flow chart 600 may represent a method of providing a multimedia service. It may be perceived that the method in accordance with the present invention includes steps that are performed at the media managing server 104.

At step 602, an authorization is transmitted from the media managing server 104 to the first client device 102 on reception of a request to establish a multimedia session or service. A multimedia session is established with the source or media provider system 106 in accordance with the request and predefined policies, at step 604. At step 606, the multimedia content from the source is received in accordance with the request. The set of preferences is received from the user of the first client device 102 to process the multimedia content received from the source, the step is denoted by 608. The multimedia content is processed in accordance with the request and the set of preferences provided by the user of the first client device 102, the step is denoted by 610. In an embodiment, the multimedia content is mixed, transcoded, or processed with the peer content based on the set of preferences. Thereafter, the multimedia content is delivered to the first client device 102 at step 612. In an exemplary embodiment, a social communication such as telepresence or multimedia chat session is established between the first client device 102 and the second client device 110, the step is denoted as 614.

Embodiments of the present subject matter may be implemented in conjunction with modules, including functions, procedures, data structures, and application programs, for performing tasks, or defining abstract data types or low-level hardware contexts. Machine-readable instructions stored on any of the above-mentioned storage media may be executable by a processor.

The present embodiments have been described with reference to specific example embodiments; it will be evident that various modifications and changes may be made to these embodiments without departing from the broader spirit and scope of the various embodiments. Furthermore, the various devices, modules, selectors, estimators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

1. An apparatus for utilizing a multimedia session, the apparatus comprising:
a processor;
a memory connected to the processor, the memory configured with one or more programs to perform set of steps with the assistance of processor, the set of steps including:
enabling viewing of a multimedia content from a media provider system;
establishing social communication with one or more client devices that are enabled for viewing the multimedia content; and
integrating the view of the multimedia content and the social communication with the one or more client devices.

2. The apparatus as recited in claim 1, wherein the one or more programs in the memory with the assistance of processor further performs the step of:
distributing multimedia content to the one or more client devices; and
distributing multimedia content to one or more media output devices.

3. The apparatus as recited in claim 2, wherein the one or more programs in the memory with the assistance of processor further performs the steps of:
generating multimedia content for an immersive content experience; and
distributing multimedia content for the immersive content experience.

4. The apparatus as recited in claim 2, wherein the one or more programs in the memory with the assistance of processor further performs the steps of:
retrieving the multimedia content to enable sharing with the one or more client devices and the one or more output devices.

5. The apparatus as recited in claim 1, wherein in establishing the social communication with the one or more client devices, the one or more programs in the memory with the assistance of processor further performs the steps of:
retrieving a list of participants of the multimedia session;
establishing the multimedia session with one of the list of the participants; and
receiving updates on the multimedia session of each of the list of the participants.

6. The apparatus as recited in claim 1, wherein in enabling viewing of the multimedia content from the media provider system, the multimedia content is received through a media managing server.

7. A system for utilizing an immersive multimedia service, the system comprising:
a media managing server for providing the immersive multimedia service; and
a first client device connected to the media managing server to utilize immersive multimedia service, the first client device comprises:
a processor; and
a memory connected to the processor, the memory comprising:
a media handling module configured for managing sensory inputs and customized outputs that are characteristic to the immersive multimedia service; and
a social communicator assisting in providing immersive multimedia service, configured for enabling social communication of the first client device with a second client device though the media managing server based on a set of user preferences provided by the user.

8. The system according to claim 7, wherein the media handling module further comprises:
a media capturing module for receiving sensory inputs that are captured by capturing devices and are characteristic to the immersive multimedia service subscribed by the user of the first client device; and
a media rendering module for providing outputs in accordance set of user preferences directed to the immersive multimedia service provided by a user of the first client device.

9. The system according to claim 8, wherein the media handling module further comprises a media control module controlling the sensory inputs and the outputs requested by the user of the first client device based on the set of user preferences on the immersive multimedia service.

10. The system according to claim 7, wherein the media managing server configured to provide the immersive multimedia service in accordance with the set of user preferences and polices.

11. The system according to claim 7, wherein the media managing server includes a media services module configured to perform at least one step of:
converting multimedia provided in accordance with the user preferences and policies;
retrieving a multimedia content from a media provider system in accordance with an immersive multimedia service request from the first client device;
storing the multimedia content pertaining to the immersive multimedia service request; and
serving the multimedia content to the first client device.

12. The system according to claim 7, further comprising a media provider system configured for providing contents requested by the user of the first client device, the content provider system is connected to the media managing server, the contents being one of live and recorded media.

13. The system according to claim 12, wherein the media provider system comprises a second media handling module configured for managing output to the media managing server.

14. The system according to claim 7, further comprising a second client device connected to the first client device through the social communicator, wherein the second client device and the first client device are configured to utilize the immersive multimedia service.

15. An apparatus comprising:
a processor; and
a memory connected to the processor configured with one or more programs to facilitate an immersive multimedia session, wherein the memory comprises:
a media handling module configured for managing sensory inputs and customized outputs that are characteristic to the immersive multimedia session; and
a social communicator assisting in providing the immersive multimedia session, configured for enabling social communication of the apparatus with a second client device in concordance with the immersive multimedia session and a set of user preferences.

16. The apparatus as recited in claim 15, wherein the memory further comprises:
a media capturing module for receiving sensory inputs that are characteristic to the immersive multimedia session;
a media rendering module for providing outputs in accordance the set of user preferences directed to the immersive multimedia session; and
a media control module controlling the sensory inputs and the outputs based on the set of user preferences on the immersive multimedia service.

17. A method of managing an immersive multimedia service, the method comprising:
retrieving a set of preferences stored by a user to configure the immersive multimedia service;
transmitting a request to a server for establishing the immersive multimedia service;
providing a source of multimedia content along with the request to establish the immersive multimedia service; and
receiving a processed from the server based on the set of user preferences and predefined policies.

18. The method as recited in claim 17, wherein in transmitting the request to the server for establishing the immersive multimedia service, the step comprises:
transmitting the set of preferences provided by the user is directed towards the immersive multimedia service.

19. The method as recited in claim 17, further comprising receiving an authorization from the server on receipt of the request.

20. A method of providing an immersive multimedia service, the method comprising:
transmitting an authorization on receiving a request for a multimedia content from a first client device;
establishing a multimedia transfer session with a source that can provide the multimedia content in accordance with the request and predefined policies;
processing the multimedia content by mixing and transcoding in accordance with the request and the predefined policies; and
delivering the multimedia content to the first client device to provide the immersive multimedia service.

21. The method according to claim 20, wherein in transmitting the authorization on receiving the request, the step comprises:
receiving a set of preferences provided by a user of the first client device along with the request.

22. The method according to claim 20, wherein in establishing the multimedia transfer session with the source, the step comprises:
receiving the multimedia content from the source to enable establishment of the multimedia transfer session.

23. The method according to claim 20, further comprising:
establishing a social communication between a second client device and the first client device.
